(19) United States
(12) Patent Application Publication
(10) Pub. No.: US 2012/0134425 A1
(43) Pub. Date: May 31, 2012

(54) Method and System for Adaptive Interpolation in Digital Video Coding

(76) Inventors: Faouzi Kossentini, North Vancouver (CA); Nader Mahdi, Sfax (TN); Mohamed-Ali Ben Ayed, Sfax (TN); Hassen Guermazi, Sfax (TN); Michael Horowitz, Austin, TX (US)

(21) Appl. No.: 13/286,828

(22) Filed: Nov. 1, 2011

Related U.S. Application Data
(60) Provisional application No. 61/417,498, filed on Nov. 29, 2010.
(60) Provisional application No. 61/500,295, filed on Jun. 23, 2011.

(51) Int. Cl. H04N 7/26

(52) U.S. Cl. 375/240.25; 375/E07.027

(57) ABSTRACT

Disclosed are techniques for adaptive interpolation filtering of luminance and chrominance samples in the context of motion compensation in video encoding or decoding. A two-dimensional interpolation filter of n×m coefficients may be separable, i.e., it may be separated into two one-dimensional filters with m and n coefficients, respectively. The bitstream may include, per video unit and sub-sample position, information indicating whether to use a newly-generated, a cached, or a default filter that may be a separable two-dimensional filter. The information may be structured in a way that takes advantage of the two-dimensional filter being separable. When a newly-generated filter is signalled, the bitstream may contain information pertaining to the characteristics of the newly-generated filter, such as its coefficients. A decoder may fetch this information from the bitstream to create the filters which are applied to samples of the video unit. An encoder may create a bitstream as described.

This application claims priority from U.S. Provisional Patent Application No. 61/417,498, filed Nov. 29, 2010, and incorporated herein by reference, and from U.S. Provisional Patent Application No. 61/500,295, filed Jun. 23, 2011, and incorporated herein by reference.

### FIELD OF THE INVENTION

This invention relates to the field of video compression, and more specifically, to a method and system for adaptive interpolation in the context of motion compensation in video encoding and/or decoding.

### BACKGROUND OF THE INVENTION

Digital video capabilities can be incorporated into a wide range of devices, including digital televisions, digital direct broadcast systems, wireless broadcast systems, personal digital assistants (PDAs), laptop or desktop computers, video cameras, digital recording devices, video gaming devices, video game consoles, cellular or satellite radio telephones, and the like. Digital video devices may implement video compression techniques, such as those described in standards like MPEG-2, MPEG-4, or ITU-T H.264/MPEG-4, Part 10, Advanced Video Coding (AVC), which are incorporated herein by reference, or according to other standard or non-standard specifications, to encode and/or decode digital video information efficiently.

A video encoder can receive uncoded video information in any suitable format, which may be a digital format conforming to ITU-R BT 601 (available from the International Telecommunications Union, Place des Nations, 1211 Geneva 20, Switzerland, www.itu.int, and which is incorporated herein by reference), for processing. The uncoded video may spatially be organized in pixel values arranged in one or more two-dimensional matrices and temporally in a series of uncoded pictures, with each uncoded picture comprising the mentioned one or more two-dimensional matrices of pixel values. Further, each pixel may comprise separate components. One common format for uncoded video that is input to a video encoder has, for each group of four pixels, four luminance samples which contain information regarding the brightness/lightness or darkness of the pixels, and two chrominance samples which contain color information (e.g., YCrCb). This format is known as YUV 4:2:0 or YCrCb 4:2:0.

The task of the video encoder is to translate uncoded pictures into a bitstream, packet stream, NAL unit stream, or other suitable format (all referred to as “bitstream” henceforth), with goals such as reducing the amount of redundancy, increasing error resilience, or other application-specific goals. The present invention addresses the removal of redundancy, a procedure also known as compression.

Conversely, a video decoder takes as its input a coded video in the form of a bitstream that may have been produced by a video encoder conforming to the same video compression standard. It translates the coded bitstream into uncoded video information that may be displayed, stored, or otherwise handled.

Both video encoders and video decoders may be implemented using hardware and/or software options. Implementations of either or both may involve programmable hardware components such as general purpose CPUs (such as found in PCs), embedded processors, graphic card processors, DSPs, FPGAs, or others. To implement at least parts of the video encoding or decoding, instructions may be needed, and those instructions may be stored and distributed using a computer readable media. Computer readable media choices include CD-ROM, DVD-ROM, memory stick, embedded ROM, or others.

Video compression and decompression refer to the operations performed in a video encoder and/or decoder. A video decoder may perform all, or a subset of, the inverse operations of the encoding operations. Unless otherwise noted, whenever techniques of video encoding are mentioned herein, the inverse of video encoding (namely video decoding) techniques are also meant to be included, and vice versa. A person skilled in the art is readily able to understand the relationship between video encoding and decoding in the aforementioned sense.

Video compression techniques may perform spatial prediction and/or temporal prediction to reduce or remove redundancy inherent in many video sequences. One class of video compression techniques commonly found is known as intra coding. Intra coding relies on spatial prediction to reduce or remove spatial redundancy between video blocks within a given video unit (e.g., picture, slice, macroblock, or Coding Unit in the terminology of the JCT-VC committee, whose work may result in a new video compression standard known as HEVC/H.265). The HEVC/H.265 working draft is set out in Wiegand et. al., “WD3: Working Draft 3 of High-Efficiency Video Coding, JCTVC-E603”, March 2011, henceforth referred to as “WD3”, and incorporated herein by reference.

A second class of video compression techniques is known as inter coding. Inter coding relies on temporal prediction from one or more reference pictures to reduce or remove redundancy between blocks of a video sequence. A block may consist of a two-dimensional matrix of sample values, which may be smaller than the uncoded picture. In ITU Rec. H.264 (available from the International Telecommunications Union, Place des Nations, 1211 Geneva 20, Switzerland, www.itu.int, and which is incorporated herein by reference), as an example, block sizes include 16×16, 16×8, 8×16, 8×8, 8×4, 4×8 and 4×4.

For inter coding, a video encoder can perform motion estimation and compensation to identify prediction blocks that closely match blocks in a video unit to be encoded, and generate motion vectors indicating the relative displacements between the to-be-coded blocks and the prediction blocks. The motion vectors may be expressed in full samples or fractions of samples as discussed in more detail below. In modern video coding standards such as H.264 or WD3, motion vectors can also have a temporal component, in that they can reference data of reference pictures other than the most recent reference picture. The difference between the motion-compensated (i.e., prediction) blocks and the original blocks forms residual information that may be compressed using techniques such as discrete cosine transformation, quantization, and entropy coding. In summary, the information to characterize an inter coded block comprises motion vector(s) and residual information.

In some video coding standards, such as H.264 or WD3, the spatial (horizontal and vertical) components of motion vectors may have full-sample (a.k.a. integer-sample) values or sub-sample (a.k.a. fractional-sample) values, allowing a standard-compliant video encoder to track motion with higher precision compared to using motion vectors with only full-sample values. To generate prediction blocks with motion vectors of sub-sample values, an encoder may apply an interpolation approach to the relevant part of a reference picture to produce values at such sub-sample positions. However, the motion compensation engine can also include an interpolation step for the full-sample positions.

Video compression standards often describe the bitstream syntax and the decoder operation for a compliant bitstream. The operation of an exemplary decoder, with an emphasis on the motion compensation mechanism as present in WD3, will now be described.

Referring to FIG. 1, a decoder 100 can parse and entropy-decode the received bit stream 101 and reconstructs a (possibly) predicted picture that can be stored in a current picture buffer 109. In the case of the picture being predicted, the reconstruction can involve one or more reference picture(s) that can be the result of previous reconstructions, and can be stored in a buffer 112. The reconstruction can also involve motion information 114 such as motion vectors, reference picture lists, reference picture index and others. The reconstruction can further involve a prediction error signal (also known as residual information) 115, that can be contained in encoded form in the bitstream 101. By combining, in each reconstruction unit 116, the prediction error data with the prediction data 120, a decoder can produce a reconstructed video picture 117 that can, possibly after in loop filtering 107 and 119, be stored in the current and reference picture buffers 109 112, and used for future prediction.

More specifically, functional units of a decoder can include a bitstream buffering unit 102 that can receive a compressed bitstream, packet stream, NAL unit stream, or any other suitable compressed input format, henceforth “bitstream” 101, an entropy decoder 103 which entropy-decodes the bitstream 101 to produce syntax elements used in subsequent processing by the other decoder 100 components. A motion compensated prediction 113 unit can be used to produce the predicted picture. An inverse scanning and quantization unit 104, and inverse transform unit 105 can be used to reproduce the coded prediction error 115 by inverse scanning, for example in zigzag order, the coded coefficients, de-quantizing the inverse-scanned coefficients, and transforming the de-quantized coefficients using an appropriate transform, such as a Discrete Cosine Transform, Integer Transform, or other transform specified in the video compression standard. A reconstruction unit 116 can add the prediction error samples 115 to the predicted samples 120 that can be stemming from the output of an inter/intra multiplexer 111, so as to produce the reconstructed picture 117, which can be stored in a temporary buffer 106. The reconstructed picture can be fed to a de-blocking filter 107 that can, for example, smooth the block boundaries within the reconstructed picture 117 to produce the filtered reconstructed picture 118. The reconstruction process can also involve an adaptive loop filter 119 which can suppress the quantization noise and can improve the objective and subjective qualities of the reconstructed picture 118 simultaneously.

The various syntax elements in the bitstream 101 can be de-multiplexed for use in different units within the decoder 100. High-level syntax elements can include temporal information for each picture, picture coding types and picture dimensions. The coding can be based on Coding Units (CUs) which are roughly equivalent to macroblocks in some earlier video compression standards. On the CU level, syntax elements can include the coding modes of the CU, motion information 114, such as motion vectors, and/or spatial prediction information 108, such as intra prediction modes, that can be required for forming the predicted samples of the Prediction Units (PUs). A PU can be the syntactical unit to which sample-based prediction is applied. PUs are roughly equivalent to blocks in some previous video compression standards.

The predicted samples of a PU can be generated either temporally (inter prediction) or spatially (intra prediction). The prediction of intra coded PUs is always based on neighbouring sample values that have already been decoded and reconstructed.

The prediction of an inter coded PU can be specified by motion vector(s) that can be associated with that PU. Referring to FIG. 2, an example 200 of motion prediction is shown, using one 206 or two 204, 205 reference pictures (as is possible in profiles of H.264 and WD3). Motion vectors 201, 202, 203 indicate positions within the set of previously reconstructed reference pictures 204, 205, 206 from which the PUs 207, 208, in this example, are predicted. Up to one reference picture 206 can be referenced for a block of an inter coded PU when uni-prediction is employed to predict the subject PU 208. According to WD3, up to two reference pictures 204 205 can be referenced for a block of an inter coded PU when bi-prediction is used to predict the subject PU 207. Uni-prediction can be performed using only one motion vector 203, referencing a single reference picture 206, to generate the motion-compensated PU 208. In case of bi-prediction, up to two reference pictures 204, 205, with each picture referenced by a single motion vector 201, 202, are used to generate the motion-compensated PU 207, for example by creating a (possibly weighted) average 209 of the motion compensated sample values as addressed by the motion vectors 201 and 202.

In WD3, interpolation of the luminance and chrominance samples of reference video pictures can be necessary to determine the predicted luminance (luma) samples and chrominance (chroma) samples, respectively. In WD3, for the prediction of the luma PUs, quarter-sample accuracy can be used, and for the prediction of the chroma PUs, eighth-sample accuracy can be used. Multiple reference pictures can also be used for motion-compensated prediction. This feature can improve coding efficiency by providing a larger set of options from which to generate a prediction signal.

The available multiple reference pictures that can be used for generating motion-compensated predictions in a uni-predicted (P-)slice or bi-predicted (B-)slice are, according to WD3, organized into two ordered sets of pictures. A given picture can be included in both sets. The two sets of reference pictures are referred to as List 0 and List 1 and the ordered position at which each picture appears in each list is referred to as its reference index.

FIGS. 3 and 4 show details of the interpolation for motion compensation assuming an YCrCb 4:2:0 sampling structure with quarter-sample accuracy and eight-sample accuracy for luma and chroma (respectively), which is what is used in WD3.

Referring to FIG. 3, the positions labelled with upper-case letters Ai, j within shaded blocks represent luma samples at full-sample locations inside a given two-dimensional array 300 of luma samples. These samples may be used for generating the predicted luma sample values. The positions labelled with lower-case letters within un-shaded blocks represent the fractional-sample positions for quarter-sample luma interpolation. More specifically, the positions marked “a” through “r” with (0, 0) indices are the 15 fractional-sample positions of the sample A. The full-sample position 301 represents the (0, 0) vector. For this position, interpolation filtering, according to WD3, is not necessary for motion compensation, but may be employed in a full-sample loop filtering mechanism. Position 302 with a horizontal ¼-sample position and a vertical full-sample position represents the (0.25, 0) vector; position 303 with a horizontal ½-sample position and a full-sample vertical position represents the (0.5, 0) vector; position 304 with a horizontal ¾-sample position and a full-sample vertical position represents the (0.75, 0) vector; position 305 with a horizontal full-sample position and a ¼-sample vertical position represents the (0, 0.25) vector; and so on.

Referring to FIG. 4, the positions labelled with upper-case letters Bi, j within shaded blocks represent chroma samples at full-sample locations inside a given two-dimensional array 400 of chroma samples. In this example, assuming quarter-sample motion resolution is used for the luma samples, and assuming a luma/chroma 4:2:0 sampling structure, an eighth-sample resolution would be required for chroma interpolation. The values at the eighth-sample positions may be used for generating the predicted chroma sample values. The positions labelled with lower-case letters within un-shaded blocks represent the 63 fractional-sample positions for eighth-sample chroma interpolation. The full-sample position 401 represents the (0, 0) vector. For this position, interpolation filtering is not necessary for motion compensation, but may be employed as a full-sample loop filtering mechanism. Position 402 with a horizontal ⅛-sample position and a vertical full-sample position represents the (⅛, 0) vector; position 403 with a horizontal ¼-sample position and a vertical full-sample position represents the (¼, 0) vector; position 404 with a horizontal 3/8-sample position and a vertical full-sample position represents the (⅜, 0) vector; position 405 with a horizontal ½-sample position and a vertical full-sample position represents the (½, 0) vector; and so on.

For a number of reasons, in previous video coding standards and standard proposals, chroma interpolation filtering and luma interpolation filtering do not employ the same filtering techniques. One of these reasons is that, due to the anatomy of the human eye, luma information is considered more relevant for the perceptual quality of the reconstructed video than chroma information, which leads to the use of finer quantization for luminance samples than for chrominance samples in many video codecs, which in turn, makes different filter strengths and properties advisable. Another reason is that, in YCrCb 4:2:0, there are two chrominance samples (one Cb and another Cr) for every four luminance samples, leading to different statistical properties of sample values, which in turn, makes the use of different filters advisable.

At the time of writing, in WD3, the operations of luma and chroma interpolation filtering are described in Section 8.4.2.2.2.1 and Section 8.4.2.2.2.2, respectively, and include the following.

A) Two 8-tap filters are used for the interpolation of the luminance samples and four 4-tap filters are used for the interpolation of the chrominance samples.

B) For both luma and chroma, only one one-dimensional (1D) filter (either one of the two specified luma 8-tap filters or one of the four specified chroma 4-tap filters) is needed to generate the interpolated value of each of the sub-sample positions that are aligned vertically or horizontally with the full-sample positions. For each of the remaining positions, a two-dimensional (2D) separable filter is required that is a cascade of two 1D filters; one 1D filter (either one of the two specified luma 8-tap filters or one of the four specified chroma 4-tap filters) for vertical filtering followed by a second 1D filter for horizontal filtering. In vertical 1D filtering, the filter coefficients are vertically aligned, and they are applied to vertically-aligned luma/chroma samples. In horizontal 1D filtering, the filter coefficients are horizontally aligned, and they are applied to the (already-vertically-interpolated) horizontally-aligned luma/chroma samples. Note that in WD3, the remaining positions that are aligned horizontally use the same filter for vertical filtering, and the remaining positions that are aligned vertically use the same filter for horizontal filtering.

C) For chroma interpolation filtering, the same filtering mechanism and the same filters are used for both chrominance blue and red (Cb and Cr) components. Note that in WD3, two 8-tap 1D filters, FH (used for horizontal and/or vertical filtering at the sub-sample positions that correspond to motion vectors with half-sample precision in at least one of the components) and FQ (used for horizontal and/or vertical filtering at the sub-sample positions that correspond to motion vectors with quarter-sample precision in at least one of the components), are specified for the generation of the interpolated luma values at all of the 15 sub-sample positions. The filter coefficients of FH are −1, 4, −11, 40, 40, −11, 4 and −1. The filter coefficients of FQ are −1, 4, −10, 57, 19, −7, 3 and −1. FH and FQ can be sequentially applied.

Referring to FIG. 5, which shows vertical/horizontal filter assignment for luma sub-sample positions 500, only one stage of 1D filtering, using FH or FQ, is applied to each of the sub-sample positions that are aligned vertically or horizontally with the full-sample positions. For example, aligned vertically with the full-sample position, there are three sub-sample positions. For the sub-sample position 504, FH is applied in the vertical direction, and no filter is applied horizontally, as this is a half-sample position vertically and a full-sample position horizontally. For the sub-sample positions 502 and 506, FQ is applied in the vertical direction and no filter is applied horizontally.

The remaining sub-sample positions use a vertical stage of 1D filtering with FH or FQ, followed by a horizontal stage of another 1D filtering using FH or FQ. (The order of application, horizontally or vertically first, could be specified in the video compression standard. Assuming sufficient arithmetic precision, the order of the application of the filters is not relevant as the filtering results produced both ways are mathematically equivalent, however, it can be advantageous to specify the order so as to avoid rounding errors and associated drifts when using insufficient precision in the calculations.)

Specifically, in order to create an intermediate value for a sub-sample position that is part of group 503 (a group with a vertical half-sample position), the 1D filter FH is applied during the vertical stage of filtering. Similarly, for sub-sample positions that are part of groups 501 and 505, the 1D filter FQ is applied vertically to generate an intermediate value for each of the sub-sample positions. After vertical filtering, the same filters FH and FQ are applied horizontally using the intermediate values, following the same rationale. It is important to note that, when vertical filtering is applied to the sub-sample positions that are part of group 505, the coefficients of the filter FQ are order-reversed before the vertical filtering stage. Similarly, when horizontal filtering is applied to the sub-sample positions that are part of group 507, the coefficients of the filter FQ are order-reversed before the horizontal filtering stage.

Table 508 shows the vertical/horizontal 1D filter assignment for each sub-sample position. The sub-sample positions listed in the sub-sample position column are the same as those shown in FIG. 3.

In WD3, four 4-tap 1D filters F0, F1, F2 and F3 were specified for the generation of the interpolated chroma values for YCrCb 4:2:0 (the only color sampling format defined in WD3) at all of the 63 sub-sample positions. The filter coefficients of F0 are −4, 36, 36 and −4. The filter coefficients of F1 are −5, 45, 27 and −4. The filter coefficients of F2 are −4, 54, 16 and −2. The filter coefficients of F3 are −3, 60, 8 and −4. Depending on the chroma sub-sample position, up to two filters from the described four filters can be sequentially applied. One stage of 1D filtering, using F0 or F1 or F2 or F3, is applied to each of the sub-sample positions that are aligned vertically or horizontally with the full-sample positions. The remaining sub-sample positions use a vertical stage of 1D filtering using F0 or F1 or F2 or F3, followed by a horizontal stage of another 1D filtering using F0 or F1 or F2 or F3. (The order of application, horizontally or vertically first, can be specified in the video compression standard. Assuming sufficient arithmetic precision, the order of application of the filters is not relevant as the filtering results produced both ways are mathematically equivalent, however, it can be advantageous to specify the order so as to avoid rounding errors and associated drifts when using insufficient precision in the calculations.)

Referring to FIG. 6, which shows vertical/horizontal filter assignment for chroma sub-sample positions 600, in order to create an intermediate value for a sub-sample position that is part of the group 601, the 1D filter F3 can be applied during the vertical stage of filtering. In the horizontal stage of filtering, depending on the sub-sample position, one filter from the described four filters can be applied using the intermediate values.

Historically, the filters required for the interpolation step have been fully-specified in the video coding standard, and they do not filter the full-sample positions. In H.264, for example, the use of a fixed interpolation filter for each sub-sample position for all video units is specified. The fixed interpolation filters used in WD3 have been described above. Distinguishing characteristics of WD3's filters include that they are separable and that they have square regions of support, that is, the filters FH and FQ are equal in size (number of coefficients) and the size of each of the filters FH and FQ is also the same in both the horizontal and vertical directions.

Proposals have been made to allow different filter sizes for the filters FH and FQ. This can lead to situations where the filter size in the horizontal and vertical directions can be different for those sub-sample positions that mix 1D half-sample and 1D quarter-sample positions in the horizontal/vertical directions. The 2D separable filters for such sub-sample positions could then have rectangular (non-square) regions of support. However, for all sub-sample positions that are both half-sample or quarter-sample, in the horizontal and vertical directions (henceforth called “diagonal sub-sample positions”), the same filter is applied in the horizontal and vertical directions. The 2D separable filters for such sub-sample positions would then necessarily have square regions of support. Doing so has the advantage that there is no need to use more than two 1D filters (FH and FQ). However, neither WD3 nor other proposals allow, for all sub-sample positions, for the selection of different filter lengths for the horizontal and vertical filtering stages (i.e., 2D separable filters with rectangular and non-square regions of support). For example, according to WD3 and other proposals, referring to FIG. 3, the “diagonal” sub sample positions e, g, j, p, and r employ a separable 2D filter where the same 1D filter is used in both the horizontal and vertical directions. More specifically, the same 1D filters FH (for the position j) and FQ (for the positions e, g, p, r) are applied both horizontally and vertically. Similar properties apply for the chroma plane.

The use of different filter lengths for horizontal and vertical interpolation can be desirable for many reasons. For example, most video content has more motion in the horizontal direction than in the vertical direction, and the human eye is more sensitive in sensing motion in the horizontal dimension. Accordingly, if there is a constraint on, for example, the number of compute cycles allowed for interpolation, it can be sensible to allocate more cycles to horizontal interpolation than vertical interpolation, which, in turn, can imply longer filters for horizontal than vertical interpolation. Further, experiments have shown that for certain content a long horizontal interpolation filter yields better coding efficiency. Similarly, in certain hard implementation architectures, where line buffers are expensive (i.e., as they may be implemented on fast on-chip memory), shorter vertical interpolation filters can reduce memory requirements. It can, therefore, be desirable to have the flexibility of using different filter lengths even considering the additional (specification and implementation) overhead of using such different-length filters.

In the above, it is assumed that only fixed filters are allowed. It has been shown, however, that one can improve prediction accuracy and coding efficiency by selecting (possibly for each sub-sample position) different interpolation filters for different video units.

Adaptive interpolation filtering in this sense was proposed in, for example, M. Karczewicz, Y. Ye, and Peisong Chen, “Switched Interpolation Filter With Offset,” ITU-T/SG 16, VCEG-AI35, July, 2008, which is incorporated herein by reference. This technique involves the interpolation of the prediction blocks by choosing, for each sub-sample position and video unit, one filter from several predefined interpolation filters. While the above technique provides better performance than that of H.264, one disadvantage is that its performance is not consistently good for all types of video content. For certain types of video content, none of the predefined filters may be a good solution.

Another technique of adaptive interpolation filtering (i.e., S. Wittmann, T. Wedi, “Separable Adaptive Interpolation Filter,” ITU-T SG16/Q.6 Doc. T05-SG16-C-0219, Geneva, Switzerland, June 2007, which is incorporated herein by reference) involves the generation, for each video unit, of a new filter for each sub-sample position, and the coding in the bitstream of all information defining such newly-generated filters when the new filters provide an overall better quality than that of the H.264 fixed fillers. A disadvantage of this scheme is that even if a newly-generated filter (corresponding to a specific sub-sample position) would not produce better quality than the corresponding H.264 fixed filter, it would still be included in the bitstream, wasting bits, which would in turn lead to a decrease in overall coding efficiency and (assuming a fixed bit budget) a reduction in reproduced video quality.

One shortcoming of the above proposals is the suboptimal coding efficiency due to lack of choice between a pre-defined filter (which may not incur bitstream overhead for coefficients) and newly defined filter(s) (which may be better adapted to the content). Another shortcoming is the lower coding efficiency even when only pre-defined filters are in use due to the lack of n×m filters at diagonal sub-sample positions.

A need therefore exists for an improved method and system for adaptive interpolation in digital video coding. Accordingly, a solution that addresses, at least in part, the above and other shortcomings is desired.

### SUMMARY OF THE INVENTION

The present invention provides a method and system for adaptive interpolation filtering for samples (e.g., motion compensated samples) during the encoding/decoding of digital video data. According to one aspect of the invention, a sample may be, for example, a luminance sample, a chrominance sample, or a sample of a plane not directly used for human consumption (such as, for example, a transparency/alpha plane). The filter used on samples belonging to luminance or chrominance or other planes may be different or, according to one aspect of the invention, may be the same.

The filter may be described, for example, as a two-dimensional (2D) filter, with n×m filter coefficients, which filters a rectangular area of samples n samples wide and m samples high. According to one aspect of the invention, the values for n and m may be different from each other, yielding a rectangular area of support, for at least one sub-sample position that may be a diagonal sub-sample position. According to one aspect of the invention, the values of m and n may be different for each sub-sample position, plane, reference picture and so forth.

The filter with n×m coefficients may be specified, for example, by n×m coefficients, by (n×m)/2 coefficients (taking advantage of symmetry effects), or, according to one aspect of the invention, by two one-dimensional (1D) filters with n and m coefficients, respectively. The fewer filter coefficients are used to specify the filter, the less flexibility an encoder has in optimizing the filter, and the fewer bits are potentially required for describing the 2D filter. However, the more filter coefficients that are used, the better the interpolation may be.

For at least one video unit, the encoder may be configured for at least one combination of a sub-sample position, a color plane, and a reference picture, to employ a newly-generated filter or a predefined filter. The predefined filter may be a default filter or a filter that was generated in the past and is available in a cache, filter table, or similar structure. The encoder may encode information indicative of whether a pre-defined filter or a newly generated filter is to be used. The encoder may further encode a reference that refers to the selected filter. If the newly-generated filter is used, the encoder may encode information specifying the newly-generated filter. It may further encode reference information under which the newly generated filter can be referred to. The resulting bits may be placed in one or more appropriate syntax structures, such as parameter set(s) or a video unit header(s), or another appropriate place(s) in the bitstream, or they may be made available to the decoder by other ways, for example by sending them out of band.

The combination of sub-sample position, color plane, and reference picture, may refer to individual values, classes of values, or all possible permutative values, of one or more of sub-sample position, color plane, or reference picture. For example, the combination may refer to an individual sub-sample position, all sub-sample positions with horizontal half-sample positions, all sub-sample positions with vertical quarter-sample positions, etc. Analogously, the combination may refer to individual color planes, classes of color planes (such as all chroma planes or the luma plane), or all color planes. Similarly, the combination may refer to individual reference pictures, classes of reference pictures, or all reference pictures, for example all reference pictures in List 0, or all reference pictures, or the current IDR frame only.

The present invention may be used in conjunction with an interpolation filtering technique as described in WD3, whereby, as described above, the filter properties (such as coefficients, number of filter taps, and so forth, henceforth also referred to “coefficients”) may be initialized to the corresponding default filter properties at a starting point in the encoding/decoding process (and, thereby, be the default filters). The default filters may be FH and FQ (for luma) and F0, F1, F2 and F3 (for chroma). The starting point of the filtering process may be, for example, an IDR picture. The default filter properties may be, for example, defined in the video coding standard, may be part of a sequence parameter set, and so forth.

The filters used for interpolation filtering may be updated by newly generated filters at another point in the encoding/decoding process. A newly generated filter may have similar properties as a default filter, and may be, for example, a separable filter and specified by new filters FH and FQ. The filters FH and FQ may be identified, for example, by two filter indexes, and the filters F0, F1, F2 and F3 may be identified by four filter indexes. The indexes may be, for example, placed in a video unit header or a parameter set that is (directly or indirectly) referenced by a video unit header.

According to one aspect of the invention, for each luminance or chrominance video unit, the encoder may be configured, for at least one diagonal sub-sample position, to employ a 2D filter with a rectangular (non-square) region of support. According to one aspect of the invention, the encoder may be configured, for at least one diagonal sub-sample position, to employ two different 1D filters (one for vertical application, the other for horizontal application) with different lengths during the generation of the interpolation value of the subject diagonal sub-sample position.

Conversely, a decoder may receive, in an appropriate place in the bitstream, or out of band, for at least one combination of sub-sample position, color plane, and reference picture, information indicative of the use of a pre-defined or a newly generated filter. It may further receive a reference to a predefined filter (that may be, for example, a flag indicating the use of a single pre-defined filter, an index into a filter table, and so forth), or information specifying the new filter. This information may be used in the interpolation filtering phase during the motion compensation part of the decoding.

According to one aspect of the invention, there is provided a method for video decoding, comprising: obtaining, for at least one sub-sample position, a predefined filter or a new filter; and, applying the obtained filter for the sub-sample position.

According to another aspect of the invention, there is provided a method for video decoding, comprising: obtaining, for at least one sub-sample position, a predefined filter; and, applying the obtained filter for the sub-sample position; wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in the horizontal direction has a first number of coefficients, the one-dimensional filter for use in the vertical direction has a second number of coefficients, and the first number and the second number are different.

According to another aspect of the invention, there is provided a computer readable media having computer executable instructions included thereon for performing a method of video decoding, comprising: obtaining, for at least one sub-sample position, a predefined filter or a new filter; and, applying the obtained filter for the sub-sample position.

According to another aspect of the invention, there is provided a computer readable media having computer executable instructions included thereon for performing a method of video decoding, comprising: obtaining, for at least one sub-sample position, a predefined filter; and, applying the obtained filter for the sub-sample position; wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in the horizontal direction has a first number of coefficients, the one-dimensional filter for use in the vertical direction has a second number of coefficients, and the first number and the second number are different.

According to another aspect of the invention, there is provided a data processing system, comprising: at least one of a processor and accelerator hardware configured to execute a method of video decoding, including: obtaining, for at least one sub-sample position, a predefined filter or a new filter; and, applying the obtained filter for the sub-sample position.

According to another aspect of the invention, there is provided a data processing system, comprising: at least one of a processor and accelerator hardware, configured to execute a method of video decoding, including: obtaining, for at least one sub-sample position, a predefined filter; and, applying the obtained filter for the sub-sample position; wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in the horizontal direction has a first number of coefficients, the one-dimensional filter for use in the vertical direction has a second number of coefficients, and the first number and the second number are different.

In accordance with further aspects of the present invention there is provided an apparatus such as a data processing system, a method for adapting this apparatus, as well as articles of manufacture such as a computer readable medium or product having program instructions recorded thereon for practising the methods of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a hybrid video decoder in accordance with an embodiment of the invention;

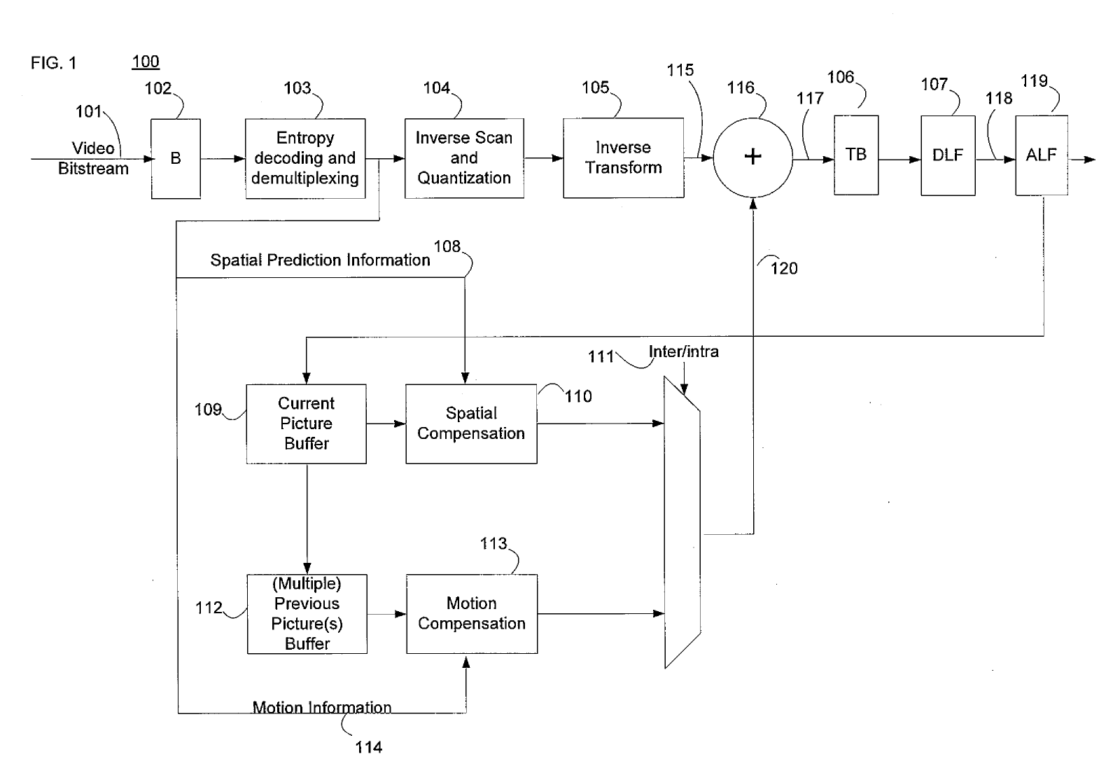

FIG. 2 is a block diagram illustrating an example of bi-predictive and uni-predictive motion compensated prediction in accordance with an embodiment of the invention;

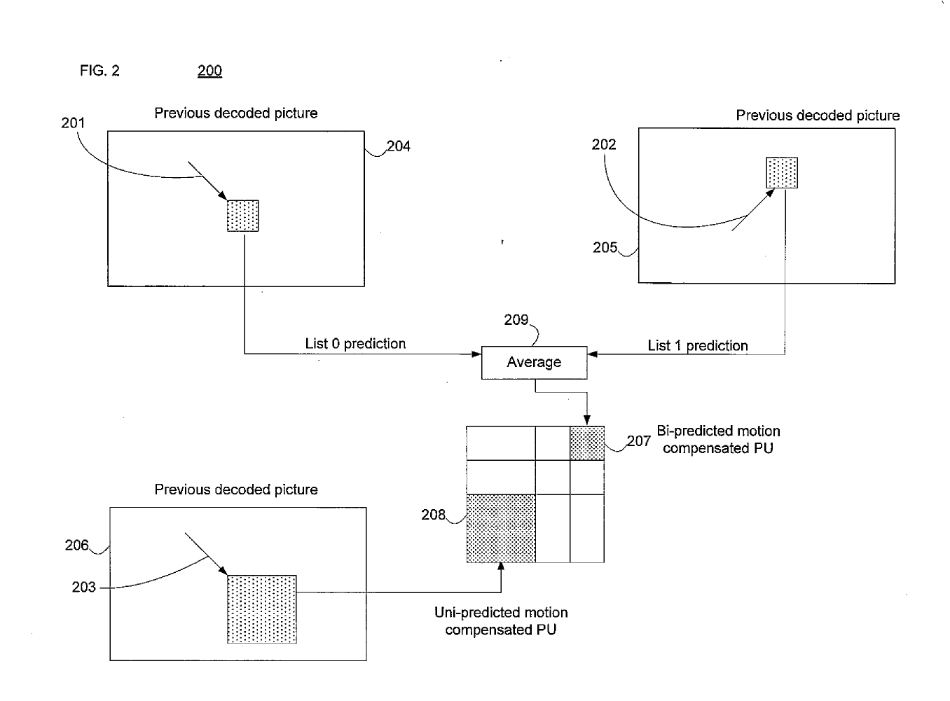

FIG. 3 is a block diagram illustrating the sub-sample positions for luma motion compensation using motion vectors of ¼-sample resolution in accordance with an embodiment of the invention;

FIG. 4 is a block diagram illustrating the sub-sample positions for chroma motion compensation using motion vectors of ⅛-sample resolution in accordance with an embodiment of the invention;

FIG. 5 is a block diagram illustrating the vertical/horizontal filter assignment for luma sub-sample positions in accordance with an embodiment of the invention;

FIG. 6 is a block diagram illustrating the vertical/horizontal filter assignment for chroma sub-sample positions in accordance with an embodiment of the invention;

FIG. 7 is an exemplary filter table in accordance with an embodiment of the invention;

FIG. 8 is an exemplary filter table in accordance with an embodiment of the invention;

FIG. 9 is a block diagram illustrating a grouping example in accordance with an embodiment of the invention;

FIG. 10 contains two tables illustrating all possible filter modes for luma and chroma filtering in accordance with an embodiment of the invention;

FIG. 11 is a flow diagram illustrating the selection of the interpolation filters and encoding of related information in accordance with an embodiment of the present invention;

FIG. 12 is a flow diagram illustrating encoder and decoder operation in accordance with an embodiment of the invention;

FIG. 13 is a flow diagram illustrating an example of the coding of the coefficients of the newly-generated filter in accordance with an embodiment of the invention;

FIG. 14 is a flow diagram illustrating the generation and the selection of the interpolation filters in accordance with an embodiment of the present invention;

FIG. 15 is a flow diagram illustrating the decoder handling of the interpolation filter information in accordance with an embodiment of the present invention;

FIG. 16 is a flow diagram illustrating the decoder handling of the interpolation filter information in accordance with an embodiment of the present invention; and,

FIG. 17 is a block diagram illustrating a data processing system (e.g., a personal computer (“PC”)) based implementation in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems, wireless devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

The present invention relates to adaptive interpolation filtering for motion-compensated prediction.

The present invention provides that a video unit may be any syntactical unit that covers, at least, the smallest spatial area to which interpolation filtering may be applied. A video unit, according to this definition, may encompass, for example, the spatial area covered by what H.264 and older standards call a block, or what WD3 calls a Prediction Unit (PU). However, it is commonly much larger and may be as large as a slice or a picture.

Video units may include headers, and those headers, or information referenced by fields in those headers (such as parameter set references and parameter sets), may be an appropriate place for information referencing or specifying the interpolation filter, as described below.

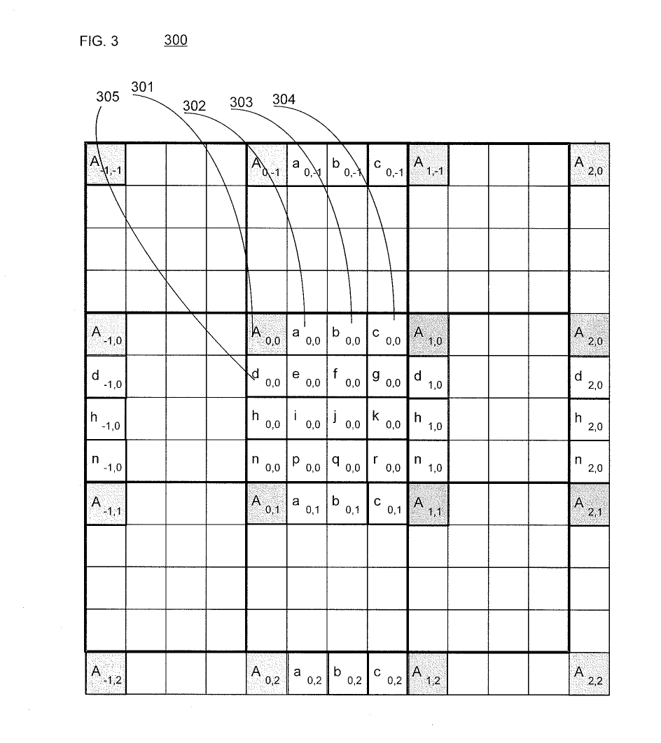

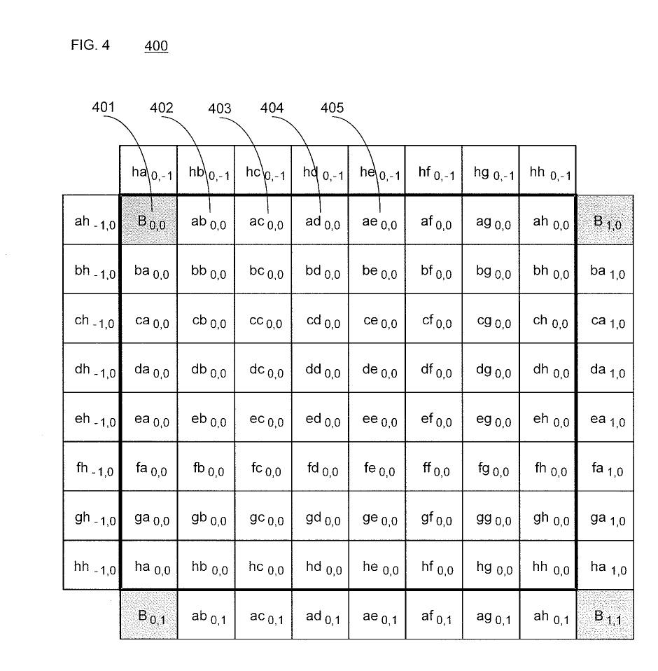

As described above in the context of FIGS. 3 and 4, a motion vector at quarter-sample resolution and for a 4:2:0 luma-chroma format can refer to up to 15 sub-sample positions on the luma plane, and up to 63 sub-sample positions on the chroma plane(s). For the full-sample positions (301 and 401), interpolation filtering may not be required, but a coding algorithm may nevertheless require filtering during the interpolation filtering stage as part of a loop filtering process (independent from the filtering that is performed for sub-sample motion compensation).

Using the same fixed interpolation filter for all sub-sample positions and all video units, it is not possible to adapt to the non-stationary (spatial and/or temporal) properties of video during the interpolation phase. However, for at least one, and possibly all, of the sub-sample positions, using a different filter for at least some of the video units would allow one to change the filter's properties in order to adapt the filter to the changing spatio-temporal characteristics of the video content. This may be true irrespective of the color plane or the reference picture whose samples are being interpolation filtered. Adapting the interpolation filter to the content and sub-sample position may be beneficial for the coding efficiency even in the light of the additional overhead (in terms of bits) that is needed to convey the adaptation information, which is described below. In some cases, it may further be advantageous to allow different adaptations for different reference pictures and/or different color planes, though using the same filters for all reference pictures and/or color planes may equally be beneficial as it may save bits in specifying or referencing the filter(s), and also may simplify the implementation of the video codec.

According to one embodiment of the invention, each filter may be separable or non-separable, its type may be IIR (with an Infinite Impulse Response) or FIR (with a Finite Impulse Response), and the filter may have a different size (i.e., the number of filter coefficients may vary from one filter to another).

According to one embodiment, each filter may be a newly-generated filter or a predefined filter, which may be a default filter or a previously-generated and cached filter (henceforth called a cached filter).

According to one embodiment, a default filter is a filter whose parameters are known between the encoder and decoder without any information exchange in the bitstream. One example of a default filter is a filter that is mandated as part of the video compression standard, and that is “hard coded” in compliant implementations of the encoder and decoder. H.264, for example, specifies that the same 1D 6-tap default filter be used for interpolation at the horizontal and vertical half-sample positions. However, there may also be other forms of default filters. For example, a default filter may be shared between the encoder and decoder by mechanisms such as a call control protocol in a video conference or a session announcement in an IPTV program. Yet another example is a filter that is known to be well performing in a certain application space and mandated by a vendor agreement or a standard outside of the video compression field.

A cached filter is a filter that has previously been generated and has been conveyed, in the bitstream or out of band, from the encoder to the decoder before it can be referenced in a bitstream by the decoder.

According to one embodiment, a two-dimensional interpolation filter (newly generated, cached, or default) may be separable, that is, it can be separated into two one-dimensional filters, to be applied in the horizontal and vertical directions, respectively. According to one embodiment, the two one-dimensional filters may have different properties, including a different number of coefficients. This allows, for example, the use of a longer filter (more coefficients) horizontally than vertically, which may have advantages both from an implementation viewpoint (fewer line buffers) as well as being a better match to most content and to the characteristics of the human eye (which is believed to be more sensitive to horizontal motion than to vertical motion).

As described above, in WD3, in order to minimize the number of filters necessary for interpolation, only two filters are used in Luma to generate the 2D filters at all of the 15 sub-sample positions. They are FH, which is used for horizontal or vertical filtering at the half-sample positions, and FQ, which is used for horizontal or vertical filtering at the quarter-sample or (after reverse ordering) ¾-sample positions. For chroma, four filters F0 through F3 are used as already described.

According to one embodiment, for luma, up to four different one-dimensional filters may be used for the various sub-sample positions. More specifically, two filters H-FH and V-FH may be used, whereby H-FH may be used for horizontal filtering at the horizontal half-sample positions and V-FH may be used for vertical filtering at the vertical half-sample positions. Similarly, H-FQ and V-FQ may be used for filtering at the corresponding horizontal/vertical quarter-sample positions.

Specifying four filters allows for the use of different filters at the horizontal and vertical half-sample or quarter-sample positions, which, in turn, allows, for example, for the use of longer filters in the horizontal direction than in the vertical direction.

The interpolation filter-related part of the bitstream, as produced by the encoder and consumed by the decoder, may contain two data structures in accordance with an embodiment of the invention. The first data structure (used for filter referencing) may be part of a video unit header and may include information arranged to indicate the use of a default filter or a cached or a newly generated filter. It may further include information to reference one out of a plurality of filters, or a group of filters. The two types of information mentioned above may be merged to a single piece of information using entropy coding techniques.

The second data structure, used for filter management, includes information arranged to manage filters (e.g., specifying new filters or filter groups, removal of cached filters, and so forth).

There are numerous options that trade the flexibility of the filter referencing and the filter design with the overhead for filter referencing and filter transmission. Two options are described for each sub-mechanism below. First to be described are two options for mechanisms for filter referencing. This is followed by a description of two options for mechanisms for filter management. Preferably, the filter reference and filter management of Option 1 are used in combination. Conversely, preferably, the filter reference and filter management of Option 2 are used in combination.

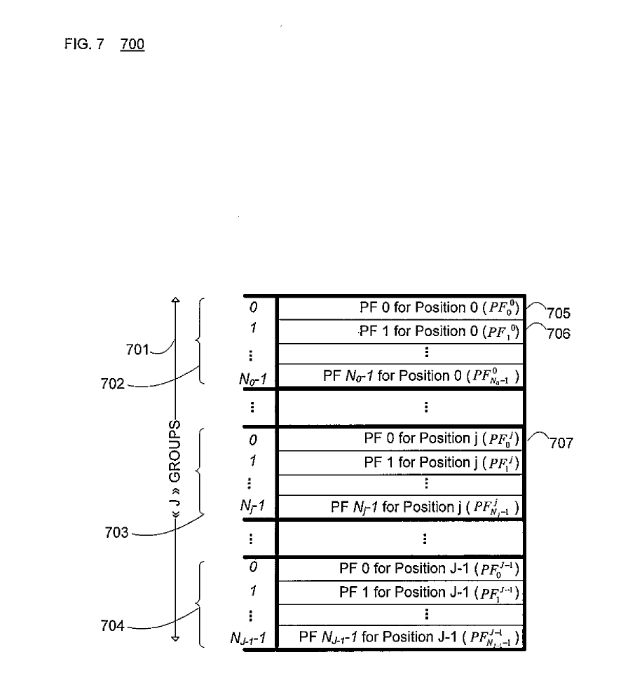

Reference Option 1: According to one embodiment, the encoder and decoder each maintains a filter table, which contains all of the predefined filters (PFs). Referring to FIG. 7, the filter table 700 may be organized in J groups 701. Shown are three groups 702, 703, 704. Each group contains directly, or by reference similar to what is described shortly, all information necessary to specify the filters for sub-sample positions. In group 702, for example, line entry 0 705 specifies the filter for the full-sample position (0, 0), line entry 1 706 specifies another filter for the sub-sample position (0, 0), and so forth. In group 703, for another example, line entry 0 707 specifies one filter for the j^{th} sub-sample position. The specifications of the filters may include all filter properties, i.e., filter type, number of coefficients, coefficient values, and so forth. However, advantageously, the information in this table is used with an additional level of indirection, similar to what is described shortly. Also possible is that the line entries of a group may be arranged not by sub-sample position, but by reference to groups of filters, such as filters FH, FQ, or H-FH, V-FH, H-FQ, V-FQ, or similar.

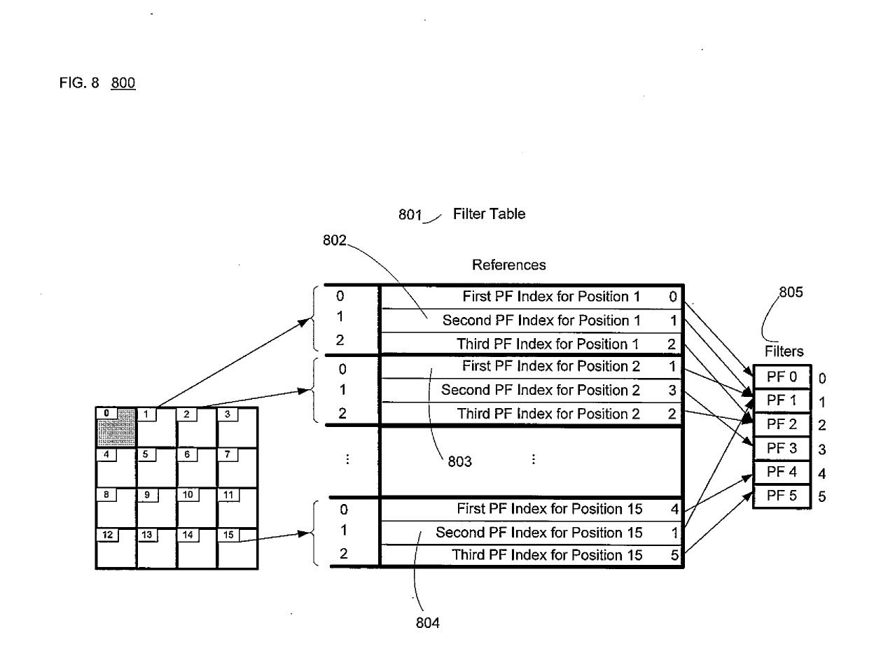

Referring to FIG. 8, shown is a different way 800 to organize a filter table 801. A referring filter table contains N entries for N positions (for YCrCb 4:2:0 luma and quarter-sample resolution, N would be 15 or 16, depending on whether the full sample position is to be filtered). Each PF index in a referring filter table 801 points to only one of 6 filters (PF0, . . . , PF5) in the definition filter table 805. The line entries in the referring filter table 805 contain all information necessary to define a filter. Note that the index of the second filter for Position 1 802, the index of the first filter for Position 2 803 and the index of the second filter for Position 15 804 refer to the same filter PF1 in the filter table 805. In a standard, the number of filters advantageously is limited so to facilitate decoder design, allowing a decoder manufacturer to provision for the maximum memory required for the table. An organization of a filter table as described here allows for the minimization of the number of filter definitions, and still allows high flexibility in the filter design.

According to one embodiment, the filter index can be encoded in binary integer format. However, using binary encoding for the index may not be the most coding-efficient choice, and therefore, the filter references may advantageously be encoded efficiently using the entropy coding format used in the video compression standard (e.g., CABAC in the High Profile of H.264).

The overhead for placing filter indexes (a.k.a. filter references) in a video unit header (e.g., slice header) may still be too high to outweigh the coding efficiency gains provided by using the present invention. This is especially true since each sub-sample motion vector may have its own filter index. In WD3 and for luma planes, for example, there are 16 different motion vectors, each of which, according to the invention, may use its own filter for interpolation filtering. In future video compression standards, conceivably, the motion accuracy may go up further, and as a result, the number of filters would grow dramatically. For example, assuming ⅛-sample motion accuracy, 64 different filters may be used for each video unit. Therefore, it is often beneficial to “group” the sub-sample positions into clusters of positions which, with a high probability, share similar filter attributes, and where each group may be referred to by a single reference in the filter table.

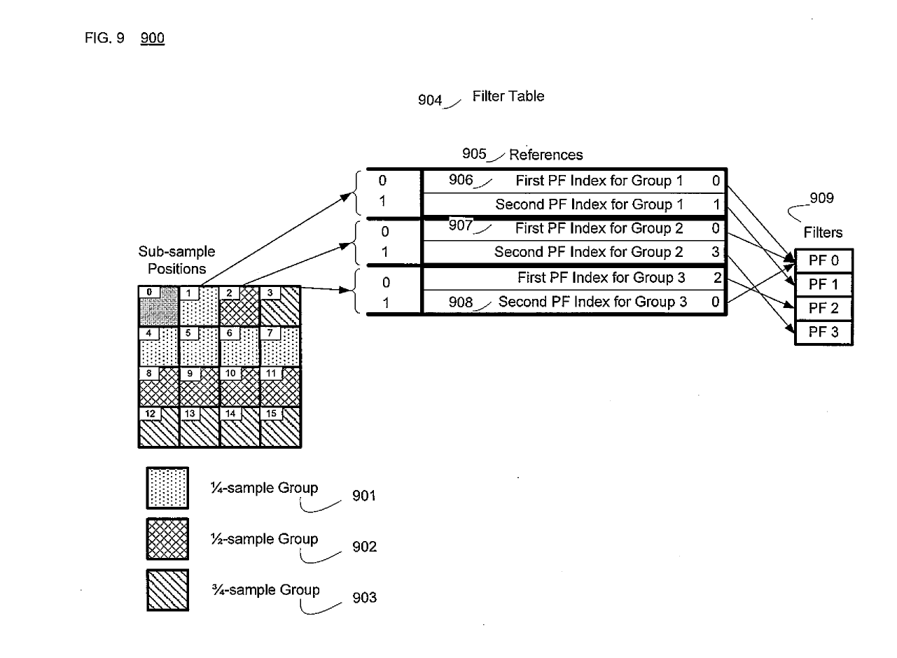

According to one embodiment, the sub-sample positions may be grouped by exploiting symmetry properties, where the PFs may be arranged as shown in the following example (with only 4 PFs and Nj=2 for all positions). Referring to FIG. 9, the list of sub-sample positions is divided 900 into three groups: the first group contains the ¼-sample positions 901, the second group contains the ½-sample positions 902 and the third group contains the ¾-sample positions 903. Since there are only four predefined filters 909 in the filter table 904, two or more indexes 905 may refer to the same filter 909 in the filter table 904. In this example, the index of the first filter for Group 1 906, the index of the first filter for Group 2 907 and the index of the second filter for Group 3 908 refer to the same filter PF0 909 in the filter table 904.

It should be noted that information pertaining to the definition of the filter tables mentioned above may be within a single parameter set (as an example for a high level syntax structure), or may be spread out over multiple parameter sets. As such, it may be possible that the filter indexes are not physically present in the bitstream but derived from other information, such as, for example, a parameter set reference.

It should further be noted that, when multiple reference pictures are in use, multiple filter references may be employed. One possible tradeoff for minimizing the referencing overhead against the gain of using different filter sets for different reference pictures is to follow the natural grouping of those reference pictures in other parts of the video codec. In WD3, for example, reference pictures are organized in two lists known as List 0 and List 1. A given reference picture can be included in both sets. According to one embodiment, the decoder chooses a set of interpolation filters depending on, possibly in addition to a filter reference, the list to which the to-be-interpolated reference picture data belongs. One possible implementation of this constraint is to have two of the different filter table mechanisms outlined above; one referenced by List 0, the other by List 1.

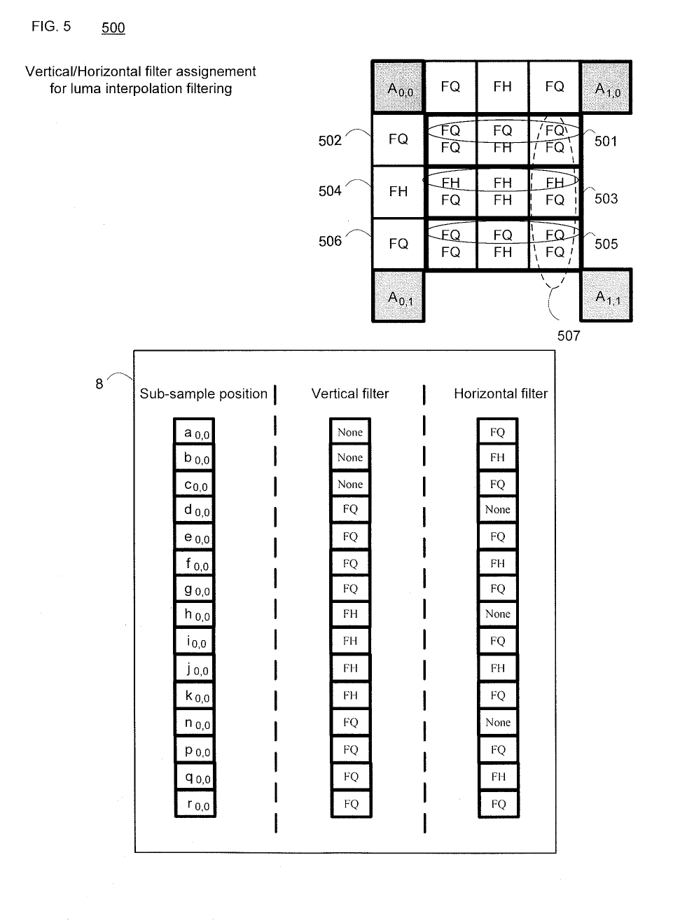

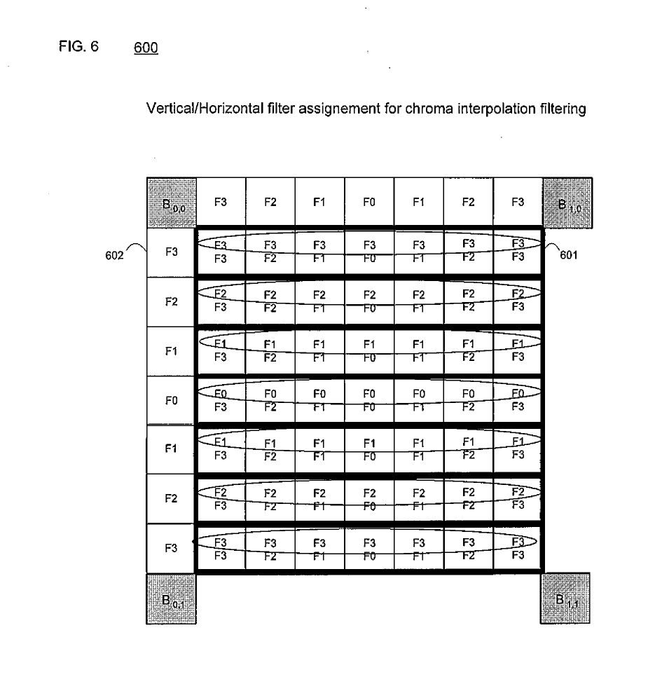

Reference Option 2: Option 2 may employ a filter table with a single entry. Accordingly, the inclusion of a filter index into the coding unit header may be redundant and may be omitted. Some of the lost flexibility may be regained by spending a few bits to configure the 2D interpolation filter such that for each of the filter categories introduced in FIGS. 5 and 6 for luma and chroma, respectively, and for horizontal or vertical application, respectively, either a new filter or a default filter (or, according to one embodiment, cached filter) may be applied.

In the following, it is assumed that only two different one-dimensional filters, FH and FQ, are used to describe the two-dimensional filters used at all luma sub-sample positions (and four such filters, F0, F1, F2, F3, for all chroma sub-sample positions). However, a person skilled in the art will easily understand that the mechanisms described below may be extended to support more (horizontal or vertical) one-dimensional filters, such as H-FH, V-FH, H-FQ, V-FQ.

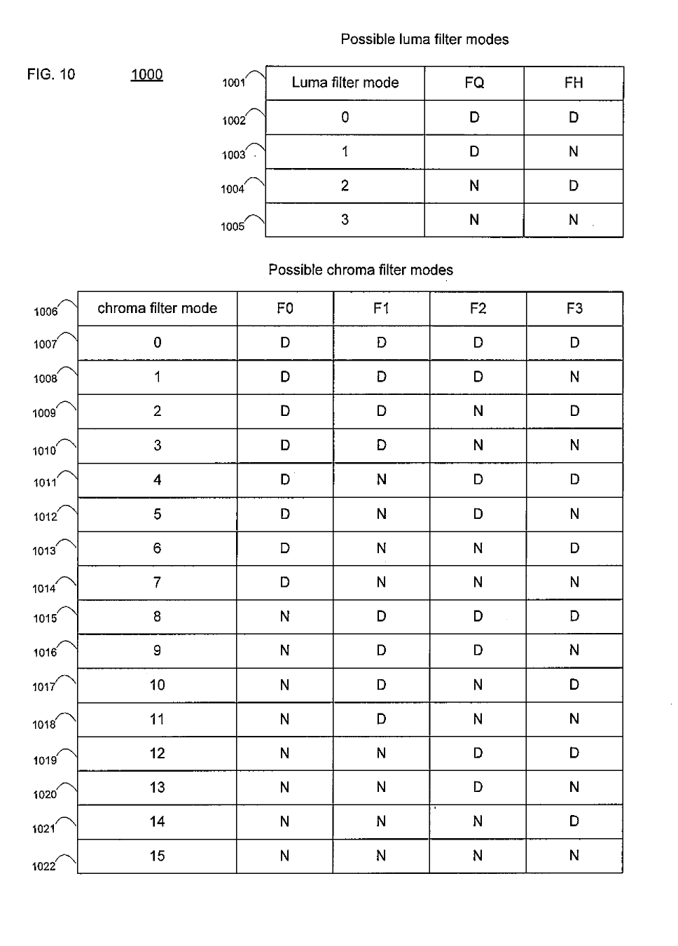

According to one embodiment, referring to the tables 1000 shown in FIG. 10, four possible luma interpolation filtering modes, identified by a luma filter mode 1001, may be applied depending on the use of default (D) or newly-generated (N) filters. If the filter mode is equal to 0 1002, default filters are assigned to FH and FQ. If the filter mode is equal to 1 1003, a default filter is assigned to FQ and a newly generated filter is assigned to FH. If the filter mode is equal to 2 1004, a default filter is assigned to FH and a newly generated filter is assigned to FQ. If the filter mode is equal to 3 1005, newly-generated filters are assigned to FH and FQ. A decoder may identify the filtering mode by parsing the luma filter mode from the bitstream that may be located, for example, in a high-level syntax structure such as a slice header.

A person skilled in the art may readily understand that the number of permutations increases as the number of one-dimensional filter increases. For example, if four one-dimensional filters such as H-FH, V-FH, H-FQ, V-FQ are in use, 16 permutations of use of the default and newly specified filters may occur and, accordingly, four bits are needed to signal the combinations.

According to one embodiment, similar mechanisms as described above in the context of luma interpolation filtering may be used for chroma interpolation filtering. For example, 16 possible chroma interpolation filtering modes, identified by a chroma filter mode 1006, may be used. The filter mode 0 1007 indicates that four default filters are assigned to the four filters F0, F1, F2 and F3, respectively. Another mode 1022 may indicate the use of a newly-generated filter for each of F0, F1, F2 and F3. The fourteen remaining modes (from 1008 through 1021) may indicate the use of one of the possible permutations of default/newly-generated filters as shown in FIG. 10. A decoder may identify the filtering mode by parsing the chroma filter mode from the bitstream, similar to the parsing of the luma mode as already described.

In an encoder, the selection between the various combinations of filter modes may be optimized as follows: for each filter mode, an accumulation error between the values of the source sample and the interpolated values may be computed. According to one embodiment, the filter mode that provides the minimum accumulation error advantageously may be selected as the best filter mode.

Having introduced the filter reference mechanism, the following description will focus on filter management.

In order to allow for drift-free decoding, at any given point in time in the decoding of a video sequence, the decoder must have identical states of control information of the interpolation filter mechanism, such as the filter table, as the encoder at the same instant of encoding. It is conceivable that the encoder's control information contains more filter definitions or similar data than the decoder's control information, but that additional information may not be meaningfully referenced by the bitstream before they are available at the decoder, because the decoder has no knowledge of its attributes.

According to one embodiment, the decoder initializes all control information, such as filters in the filter table that are not predefined, with default values such as default filter information. Initialization may occur at the start of the decoder or at other points (e.g., Independent Decoder Refresh pictures in H.264). This has at least three advantages. First, encoders not wishing to use, or are incapable of, filter management, may still create bitstreams that are compliant with the standard. They simply include any valid references into the control information (such as a filter table) and may be sure that the default filters are being used. Second, if the bitstream were to contain a reference to a filter that had been defined by the encoder, but that definition was lost in transmission to the decoder, the decoder would still have a default filter available for interpolation. This feature may be helpful in improving error resilience. Third, resetting filters to a default state at IDRs allows for splicing of bitstream fragments at these points without having to establish the correct filter states.

A default filter is a filter whose parameters are known between the encoder and decoder without any information exchange. One example of a default filter is a filter that is mandated as part of the video compression standard, and that is “hard coded” in conformant implementations of the encoder and decoder. In WD3, for example, the filter specified for luma interpolation at horizontal or vertical half-sample positions is a one dimensional 8-tap default filter, which is applied in both the horizontal and vertical directions. However, there may also be other forms of default filters. For example, a default filter may be shared between the encoder and decoder by mechanisms such as a call control protocol in a video conference or a session announcement in an IPTV program. Yet another example is a filter that is known to be well performing in a certain application space and mandated by a vendor agreement or a standard outside of the video compression field.

According to one embodiment, a filter may be generated during the encoding process. One option to generate a filter is to compute it analytically by minimizing the energy of the difference between the original picture (or relevant part of the picture, such as the spatial area covered by a slice) and the predicted picture (or corresponding part thereof), after interpolation filtering and motion compensation using a filter candidate. This newly-generated filter may be encoded in many different ways. For example, the filter coefficients may be coded as described in Y. Vatis, B. Edler, I. Wassermann, D. T. Nguyen and J. Ostermann, “Coding of Coefficients of Two-Dimensional Non-Separable Adaptive Wiener Interpolation Filter”, Proc. VCIP 2005, SPIE Visual Communication & Image Processing, Beijing, China, July 2005, which is incorporated herein by reference, where the process of coding the filter coefficients has been subdivided into three steps: quantization, prediction and entropy coding.

Filter Management Option 1: In order to manage the filter table, the encoder may need to communicate updates to the decoder. As mentioned, advantageously, the filter table may be initialized with default filters. According to one embodiment, a decoder may update its filter table, or parts thereof, by receiving a specification of the new filter that may be coded as outlined above. The update may be in any format agreed between the encoder and decoder. The update information may be entropy coded following one of the standardized methods.

In standards such as H.264 or WD3, any decoder information that pertains to more than one slice may advantageously be placed in a data structure known as a parameter set. Filter table entries may pertain to more than one slice. Therefore, updates to filter tables may be conveyed as part of an appropriate parameter set or as an update to a parameter set, if the video compression standards allows for such updates. In other standards, appropriate places for the filter table updates include video unit headers such as picture headers, as well as out-of-band transmission channels.

The encoder is free to implement any strategy of its choice to manage the finite resource of filter table entries. For example, the encoder could choose to use a FIFO (First In, First Out) strategy to purge the oldest cached entries from the table to be overwritten with newer entries.

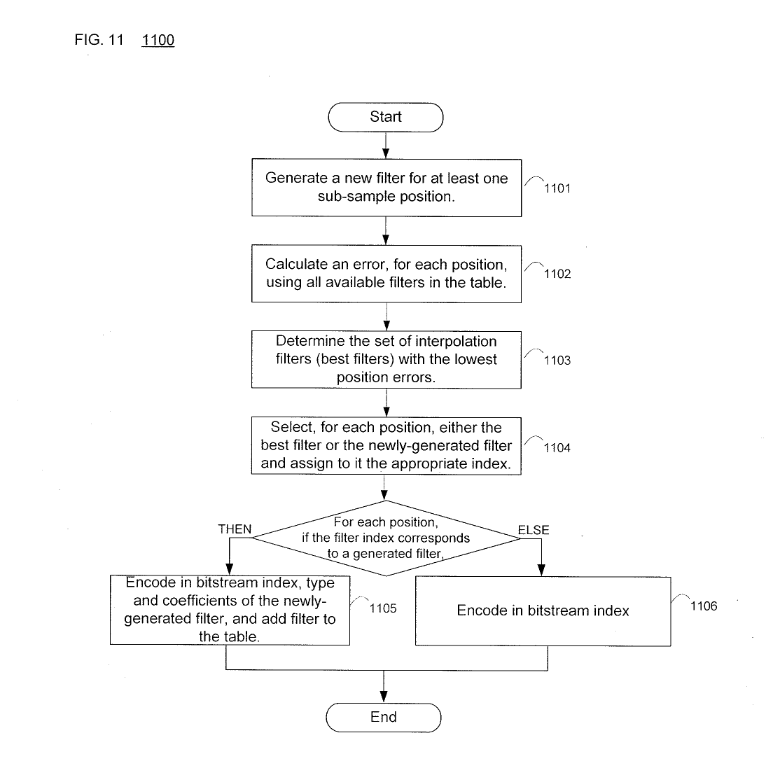

Referring to FIG. 11, shown is a flow diagram 1100 illustrating one strategy that can be used in an encoder. First, one or more new filter(s) are generated 1101 for one or more (typically all) sub-sample positions, that can be optimal for the content by computing them analytically. Methods for such computation are known to a person skilled in the art. For at least one, but typically all, sub-sample position, an accumulation error may be computed using the source sample values and the interpolated sample values using each available filter 1102 including the filters in the filter table and default filters. A best of these pre-defined filters is determined 1103. Then, the filter that provides the minimum accumulation error is selected as the best filter for the considered sub-sample position 1104. The corresponding index is placed in the video unit header 1105, 1106. When the newly-generated filter is selected, its type and coefficients are also coded, and the resulting bits are placed in the bitstream 1105.

Conversely, for each video unit and sub-sample position, the decoder may receive, in the video unit header, an index and, in a video unit header or a data structure such as a parameter set, the type and coefficients of a newly-generated filter (if the encoder choose to place a newly generated filter in the bitstream 1105), or an index that refers to one of the predefined filters for the sub-sample position (in case the encoder chooses to include only an index to a pre-defined filter in the bitstream 1106). If an index corresponds to the newly-generated filter, such a filter may be kept in the table as a predefined filter for future usage in the encoding of the next video unit 1105.

Most video compression standards standardize only the bitstream syntax and semantics and the decoder reaction to the bitstream. Following this logic, the aforementioned selection procedure may be implementation dependent and not part of the standard specification, whereas the syntax and semantics of the elements necessary to transmit the interpolation filter, or indicate the selection of the predefined filter for the sub-sample position, would be part of the standard specification.

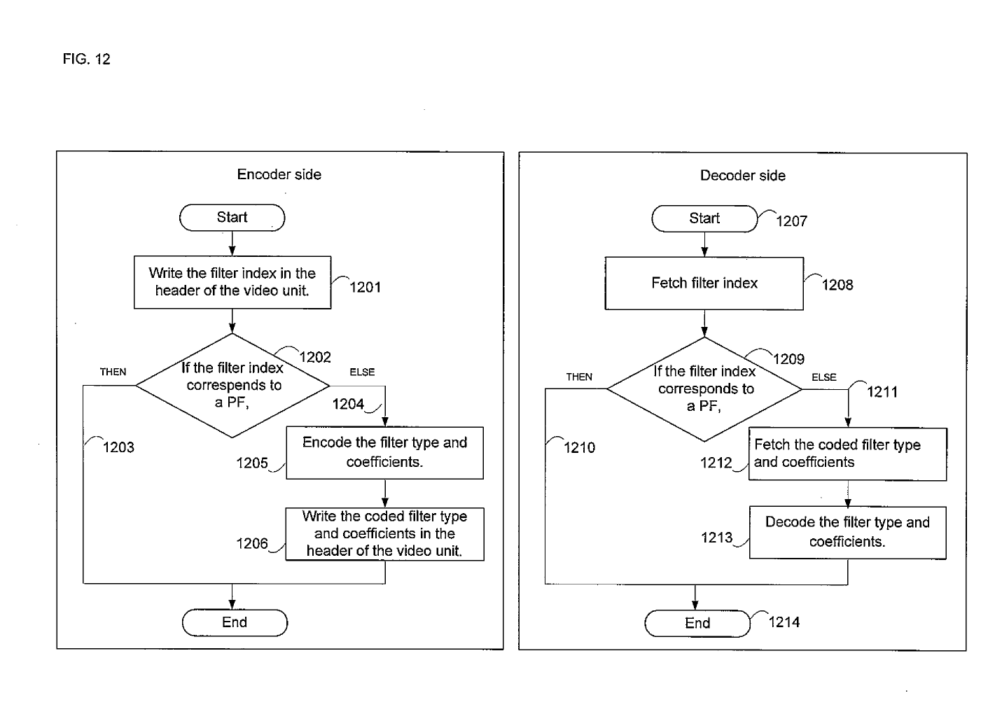

Referring to FIG. 12, the encoder and decoder operation will now be described. On the encoder side, the video unit header is first updated with the index into the filter table 1201. If that index refers to a PF 1202, no further data that is related to the filter is written to the video unit header and the bitstream generation continues 1203. If, however, the index refers to a newly-generated filter 1204, the encoder entropy-encodes the associated filter type and coefficients according to the entropy coding mechanism in use (in H.264, this could be CA-VLC or CABAC) 1205 and writes them into the video unit header or another appropriate part of the bitstream such as a parameter set 1206.

On the decoder side, the state machine that interprets the syntax and semantics of the coded video, at some point, determines that the data that is related to the interpolation filter is to be expected 1207. The nature of this determination is known to those skilled in the art. At this point, the decoder fetches the filter index for the first sub-sample position from the video unit header 1208 and examines it 1209. The term “fetch” should not be taken verbatim. It could involve any of the following mechanisms (depending on the high-level architecture of the subject video coding standard): (1) reading the information from the video unit header; (2) de-referencing a parameter set and obtaining the index from the information within; or, (3) receiving the information form an out-of-band source, and similar. Henceforth, the term “fetch” is used with this meaning.

The filter index may refer to a PF. In this case 1210, no more syntax-based activity is needed, and the decoding mechanism continues using the filter found under the index just fetched. If, however 1211, a newly-generated filter is to be expected, the decoder fetches the filter type and coefficients 1212, and entropy-decodes them according to the entropy coding scheme in use 1213. At this point, the bitstream-related processing is terminated and the fetched filter type and coefficients are used for the decoding of the sample data 1214.

Finally, it should be noted that it may be appropriate to use different filters for interpolation based on criteria other than video unit and sub-sample motion vector. For example, different filters may be used for the different color planes (as they exist in, for example, YCrCb 4:2:0 uncompressed video), reference pictures, and so forth. As such, according to one embodiment, there may be more than one filter table, with each designed for a specific criterion other than spatial area, such as a color plane or reference picture list.

Filter Management Option 2: Under option 2, the filter table can be of size 1 and therefore no referencing information into the filter table is needed. What is needed is information (assuming the use of separable 2D filters) as to which 1D filters are default and which are newly generated.

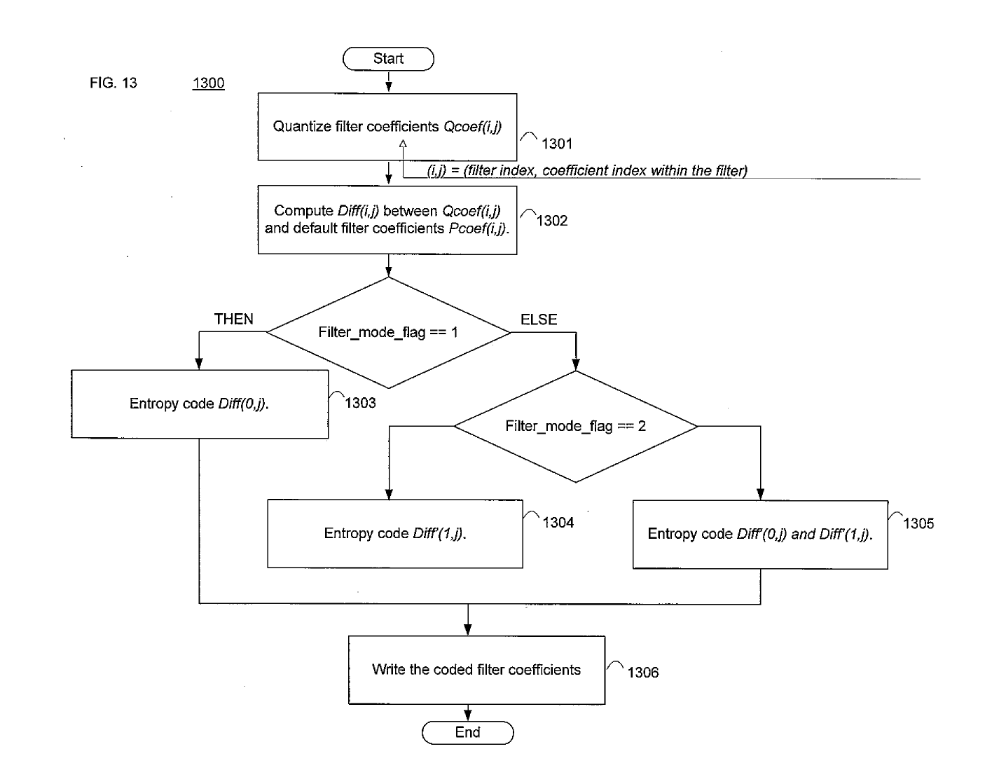

According to one embodiment, an encoder may operate as follows, using a luma filter as an example. Referring to the flow diagram 1300 shown in FIG. 13, for each filter index (two filter indexes for luma that correspond to FH and FQ), the coefficients of each newly-generated filter (that have been determined, for example, analytically) may first be quantized 1301 in a way that yields a good compromise between filter accuracy and size of the side information. A person skilled in the art may readily choose between many known optimization techniques for this trade-off, including rate-distortion analysis, cost-function based approaches, and others. The differences between the quantized coefficients and the corresponding default filter coefficients can be computed 1302. Depending on the filter mode (which indicates the newly-generated filter in contrast to a default filter), the obtained difference values may be entropy coded 1303, 1304, 1305. The obtained coded filter coefficients may be written in the appropriate video unit header 1306.

According to one embodiment, the newly-generated filter coefficients may be used during the motion compensation of PUs that have motion vector(s) pointing to the first reference picture of each of the two reference picture lists. According to one embodiment, the newly-generated filter coefficients may be used during the motion compensation of PUs that have motion vector(s) pointing to the all reference pictures of each of the two reference picture lists.

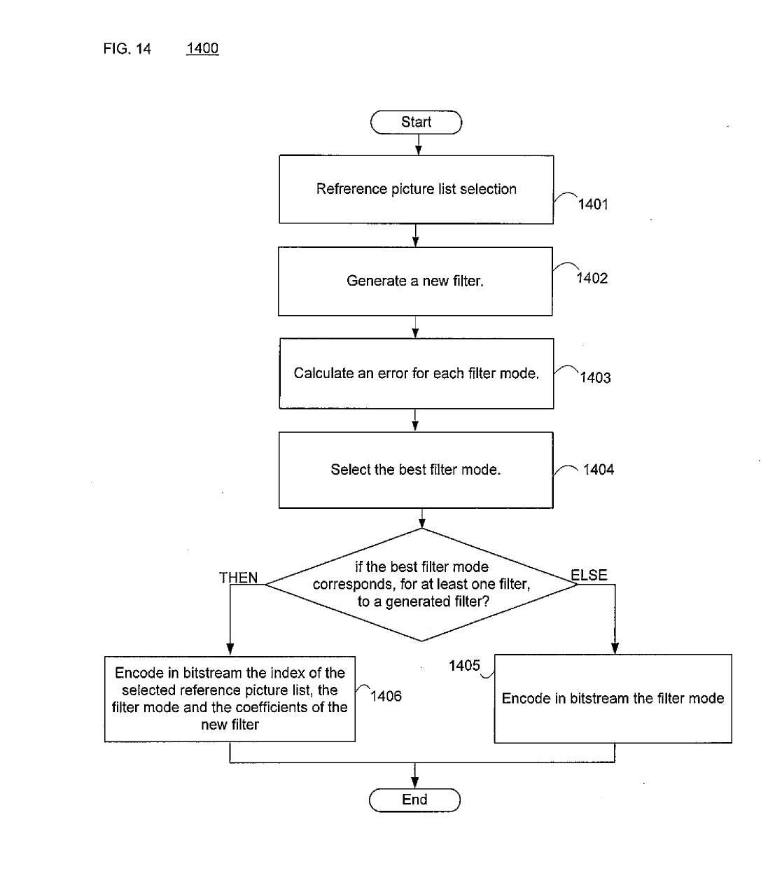

Referring to FIG. 14, shown is a flow diagram 1400 of the decision mechanisms that an encoder may employ in the context of motion compensation interpolation. According to one embodiment, an estimation of the most frequently referenced reference picture list may be performed and, according to this estimation, a reference picture list may be selected 1401. For clarity, only the first picture (that has a reference picture index equal to zero) from the selected reference picture list is shown to be used during the handling of the next steps of the flow diagram 1400, however, the mechanisms described may apply to other reference pictures as well.

According to one embodiment, for each filter index (2 filter indexes for luma that correspond to FH and FQ and 4 filter indexes for chroma that correspond to F0, F1, F2 and F3), a newly generated filter may be generated as a candidate filter 1402.

According to one embodiment, for each filter mode, an accumulated error between the value of the interpolated sample using the filters that correspond to the subject mode and the corresponding original sample may be calculated 1403.

According to one embodiment, using the errors that were, for example, generated as described, for each filter mode, a best filter mode may be selected 1404, using one or more selection criteria. According to one embodiment, the filter mode that provides the minimum accumulation error may be selected as the best filter mode 1404.

According to one embodiment, the corresponding filter_mode (luma_filter_mode for luma and chroma_filter_mode for chroma) may be placed in a video unit header 1405, 1406. When the corresponding luma_filter_mode indicates that a newly-generated filter is selected, its coefficients and the index of the selected reference picture list may also be coded, for example, in the video unit header or in a parameter set 1406.

The relationship between a video encoder and a video decoder is readily understood by a person skilled in the art. Therefore, the description of decoder operation in the following will be brief.

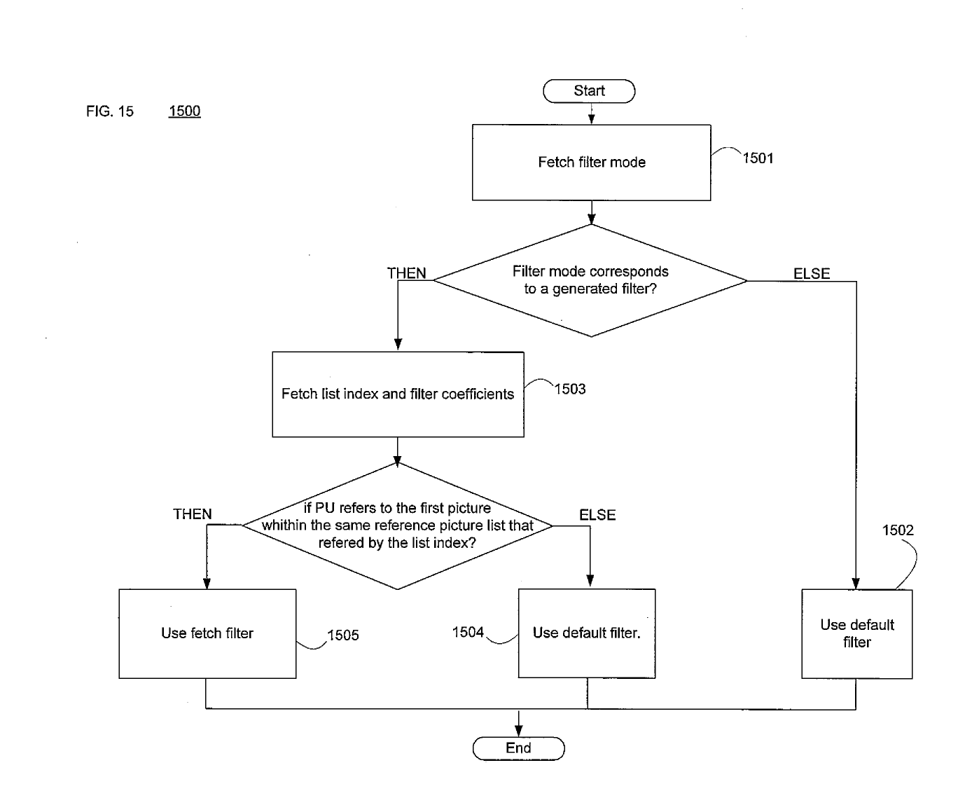

Referring to the flow diagram 1500 shown in FIG. 15, for each video unit, a decoder may fetch, for example from the video unit header, a filter mode 1501. If the filter mode indicates that the default filter is used as the interpolation filter, no additional information related to the interpolation may be present in the bitstream and the decoder may continue its processing using a default filter 1502, for example according to the mechanisms described in WD3. Otherwise, the decoder may fetch a list index of a reference picture list that may be followed by the coefficients of a newly-generated filter 1503, or a reference thereof (which may point, for example, into a parameter set). The decoder may apply those values in a manner that reverses the encoder's operation.

In the motion compensation part, if a PU refers to the first picture (that has a reference picture index equal to zero) within the same reference picture list that is referred by the already parsed list index, the received coefficients may be used for the computation of the interpolated values of the sub-sample positions 1505. Otherwise, the default filter may be used 1504.

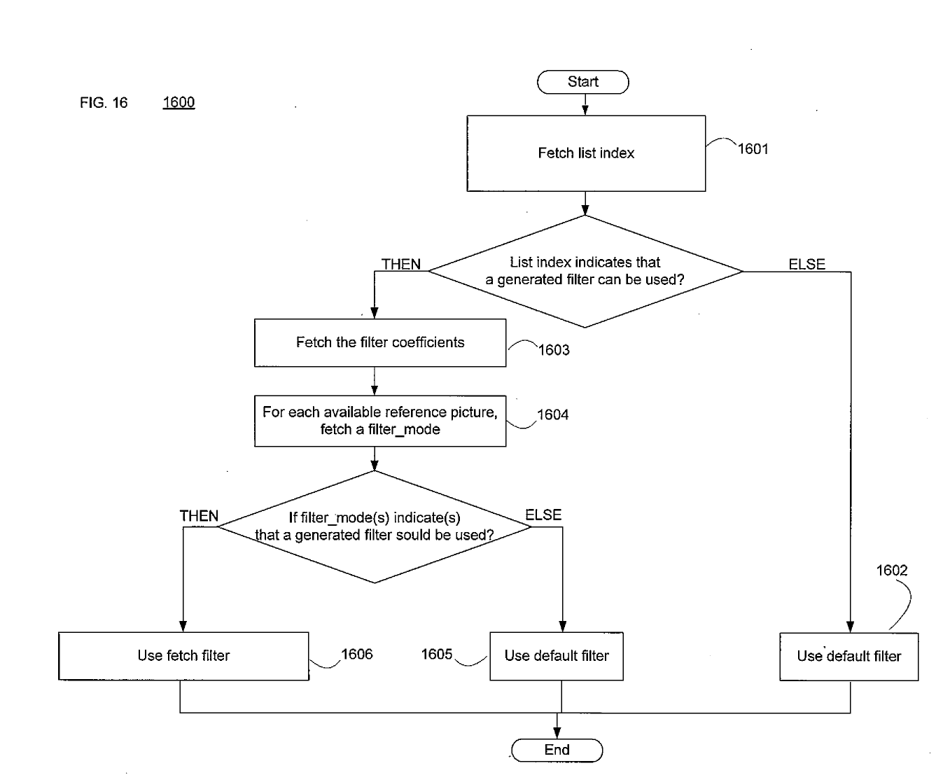

As mentioned above, the described mechanism 1400 shown in FIG. 14 may be applied to all available reference pictures as well. In this case, referring to the flow diagram 1600 shown in FIG. 16, for each video unit, a decoder may fetch, for example, from the video unit header, a list index 1601. If the list index indicates that the default filter(s) is/are used as the interpolation filter(s), no additional information related to the interpolation may be present in the bitstream and the decoder may continue its processing using the default filter(s) 1602, for example, according to the mechanisms described in WD3. Otherwise, the decoder may fetch the coefficients of the corresponding newly-generated filter(s) 1603, and may then fetch, for each available reference picture from the subject list, a filter mode 1604. For each available reference picture from the subject list, if the corresponding filter mode indicates that the default filter(s) be used as the interpolation filter(s), the decoder may perform interpolation filtering using the default filter(s) 1605. Otherwise, the decoder may perform interpolation filtering using the already fetched filter(s) 1606. The decoder may apply those values in a manner that reverses the encoder's operation.

Most video compression standards standardize only the bitstream syntax and semantics and the decoder reaction to the bitstream. Following this logic, the aforementioned selection procedure may be implementation dependent and not part of the standard specification, whereas the syntax and semantics of the elements necessary to transmit the interpolation filter, or indicate the selection of the predefined filter for a sub-sample position, as well as the decoding process required to apply the interpolation filter would be part of the standard specification.

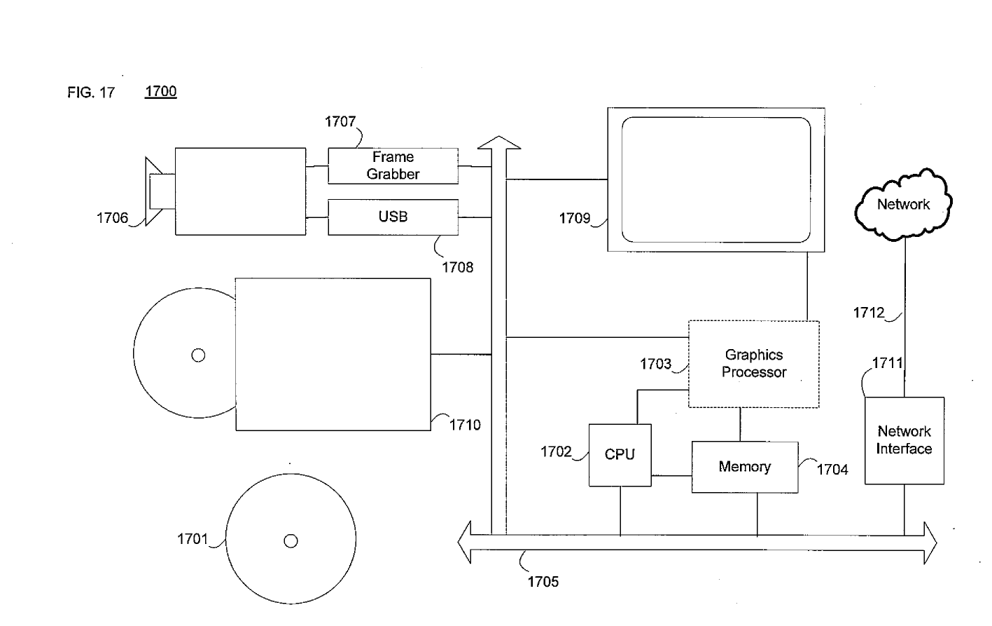

FIG. 17 shows a data processing system (e.g., a personal computer (“PC”)) 1700 based implementation in accordance with an embodiment of the invention. Up until now, the description has not described the physical implementation of the encoder and/or decoder in detail. Historically, many video encoders and decoders have been implemented in custom or gate array integrated circuits, for reasons related to cost efficiency and/or power consumption efficiency. This continues to be a viable option for an embodiment of the present invention.

However, more recently, software implementations have been made possible on many general purpose processing architectures and data processing systems 1700. Using a personal computer or similar device (e.g., set-top-box, laptop, mobile device) 1700 as an example, such an implementation strategy is described in the following. Referring to FIG. 17, according to one embodiment, the encoder and/or the decoder for a PC or similar device 1700 may be made available in the form of a computer-readable media 1701 (e.g., CD-ROM, semiconductor-ROM, memory stick) containing instructions configured to enable a processor 1702, alone or in combination with accelerator hardware (e.g., graphics processor) 1703, in conjunction with memory 1704 coupled to the processor 1702 and/or the accelerator hardware 1703 to perform the encoding or decoding. The processor 1702, memory 1704, and accelerator hardware 1703 may be coupled to a bus 1705 that can be used to deliver the bitstream and the uncompressed video to/from the aforementioned devices. Coupled to the bus 1705, depending on the application, there can be peripherals for the input/output of the bitstream or the uncompressed video. For example, a camera 1706 may be attached through a suitable interface, such as a frame grabber 1707 or a USB link 1708, to the bus 1705 for real-time input of uncompressed video. A similar interface can be used for uncompressed video storage devices such as VTRs. Uncompressed video may be output through a display device such as a computer monitor or a TV screen 1709. A DVD RW drive or equivalent (e.g., CD ROM, CD-RW Blue Ray, memory stick) 1710 may be used to input and/or output the bitstream. Finally, for real-time transmission over a network 1712, a network interface 1711 can be used to convey the bitstream and/or uncompressed video, depending on the capacity of the access link to the network 1712, and the network 1712 itself.

According to one embodiment, the above described method may be implemented by a respective software module. According to another embodiment, the above described method may be implemented by a respective hardware module. According to another embodiment, the above described method may be implemented by a combination of software and hardware modules.

While this invention is primarily discussed as a method, a person of ordinary skill in the art will understand that the apparatus discussed above with reference to a data processing system 1700 may be programmed to enable the practice of the method of the invention. Moreover, an article of manufacture for use with a data processing system 1700, such as a pre-recorded storage device or other similar computer readable medium or product including program instructions recorded thereon, may direct the data processing system 1700 to facilitate the practice of the method of the invention. It is understood that such apparatus and articles of manufacture also come within the scope of the invention.

In particular, the sequences of instructions which when executed cause the method described herein to be performed by the data processing system 1700 can be contained in a data carrier product according to one embodiment of the invention. This data carrier product can be loaded into and run by the data processing system 1700. In addition, the sequences of instructions which when executed cause the method described herein to be performed by the data processing system 1700 can be contained in a computer program or software product according to one embodiment of the invention. This computer program or software product can be loaded into and run by the data processing system 1700. Moreover, the sequences of instructions which when executed cause the method described herein to be performed by the data processing system 1700 can be contained in an integrated circuit product (e.g., a hardware module or modules) which may include a coprocessor or memory according to one embodiment of the invention. This integrated circuit product can be installed in the data processing system 1700.

The above embodiments may contribute to an improved method and system for adaptive interpolation in digital video coding and may provide one or more advantages. For example, the option of using a newly defined filter instead of a pre-defined filter, and/or the use of n×m filter coefficients at diagonal positions (even for pre-defined filters), may improve coding efficiency through a better match of the reconstructed picture with the original picture without incurring additional bitrates in the coded picture. In addition, the use of a separable 2D filter (instead of, for example, a non-separable 2D filter) may improve coding efficiency because the number of coefficients to be included in the bitstream may be small.

The embodiments of the invention described above are intended to be exemplary only. Those skilled in the art will understand that various modifications of detail may be made to these embodiments, all of which come within the scope of the invention.

What is claimed is:

1. A method for video decoding, comprising:
obtaining, for at least one sub-sample position, a predefined filter or a new filter; and,
applying the obtained filter for the sub-sample position.

2. The method of claim 1, wherein the filter is obtained for at least one video unit.

3. The method of claim 1, wherein the predefined filter includes a default filter and a cached filter.

4. The method of claim 1, wherein an information specifying the new filter is fetched from at least one of a video unit header or a parameter set.

5. The method in claim 4, wherein the new filter is separable into at least two one-dimensional filters.

6. The method of claim 5, wherein the new filter is at least partly specified in the information as at least one one-dimensional filter that is applied in at least one of a horizontal direction or a vertical direction.

7. The method of claim 5, wherein the new filter is specified in the information by two of the at least two one-dimensional filters applied to a horizontal direction and a vertical direction, respectively.

8. The method of claim 5, wherein the new filter is specified in the information by one one-dimensional filter that is applied in both the horizontal and vertical directions.

9. The method of claim 5, wherein the information comprises at least one one-dimensional filter for use in a horizontal direction, and at least one one-dimensional filter for use in a vertical direction, the at least one of the at least one one-dimensional filters for use in the vertical dimension has a first number of coefficients, the at least one of the at least one one-dimensional filters for use in the horizontal dimension has a second number of coefficients, and where the first number and the second number are different.

10. The method of claim 2, wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in a horizontal direction has a first number of coefficients, the one-dimensional filter for use in a vertical direction has a second number of coefficients, and where the first number and the second number are different.

11. The method of claim 2, wherein the sub-sample position is a diagonal sub-sample position, the new filter is a two-dimensional filter, the new filter is separable into a one-dimensional filter for use in a horizontal direction and a one-dimensional filter for use in a vertical direction, the one-dimensional filter for use in a horizontal direction has a first number of coefficients, the one-dimensional filter for use in a vertical direction has a second number of coefficients, and where the first number and the second number are different.

12. A method for video decoding, comprising:
obtaining, for at least one sub-sample position, a predefined filter; and,
applying the obtained filter for the sub-sample position;
wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in the horizontal direction has a first number of coefficients, the one-dimensional filter for use in the vertical direction has a second number of coefficients, and the first number and the second number are different.

13. A computer readable media having computer executable instructions included thereon for performing a method of video decoding, comprising:
obtaining, for at least one sub-sample position, a predefined filter or a new filter; and,
applying the obtained filter for the sub-sample position.

14. A computer readable media having computer executable instructions included thereon for performing a method of video decoding, comprising:
obtaining, for at least one sub-sample position, a predefined filter; and,
applying the obtained filter for the sub-sample position;
wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in the horizontal direction has a first number of coefficients, the one-dimensional filter for use in the vertical direction has a second number of coefficients, and the first number and the second number are different.

15. A data processing system, comprising:
at least one of a processor and accelerator hardware configured to execute a method of video decoding, including:
obtaining, for at least one sub-sample position, a predefined filter or a new filter; and,
applying the obtained filter for the sub-sample position.

16. A data processing system, comprising:
at least one of a processor and accelerator hardware configured to execute a method of video decoding, including:
obtaining, for at least one sub-sample position, a predefined filter; and,
applying the obtained filter for the sub-sample position;
wherein the sub-sample position is a diagonal sub-sample position, the predefined filter is a two-dimensional filter, the predefined filter is separable into a one-dimensional filter for use in a horizontal direction and a one-dimensional filter for use in a vertical direction, the one-dimensional filter for use in the horizontal direction has a first number of coefficients, the one-dimensional filter for use in the vertical direction has a second number of coefficients, and the first number and the second number are different.
